(19) United States
(12) Patent Application Publication
(10) Pub. No.: US 2024/0138645 A1
(43) Pub. Date: May 2, 2024

(54) CLEANING BASE STATION, CONTROL METHOD THEREOF AND CLEANING SYSTEM

(71) Applicant: SHENZHEN SILVER STAR INTELLIGENT GROUP CO., LTD., Shenzhen (CN)

(72) Inventors: Junjian Huang, Shenzhen (CN); Xue Liang, Shenzhen (CN); Yewei Kang, Shenzhen (CN); Jiwen Li, Shenzhen (CN); Lirong Ye, Shenzhen (CN)

(21) Appl. No.: 18/226,276

(22) Filed: Jul. 26, 2023

(30) Foreign Application Priority Data
Oct. 28, 2022 (CN) 202211331499.5

(51) Int. Cl. A47L 11/40; G05D 1/02

(52) U.S. Cl. CPC A47L 11/4091; A47L 11/4005; A47L 11/4011; A47L 11/4025; A47L 11/4083; G05D 1/0225; A47L 2201/022; A47L 2201/024; A47L 2201/026; A47L 2201/028; A47L 2201/04; G05D 2201/0203

(57) ABSTRACT

A cleaning base station includes a base, a first electrode, an infrared module, and a guiding member. The base includes an open chamber accommodating a cleaning robot, and the open chamber includes a chamber sidewall extending in an arc shape. The first electrode is arranged on the chamber sidewall and contacts a second electrode of the cleaning robot. The infrared module is arranged on the chamber sidewall and aligns the cleaning robot. The guiding member is arranged on the chamber sidewall and protrudes from the chamber sidewall, the guiding member is capable of extending into a guiding groove defined on the cleaning robot, the guiding member includes a guiding part, the guiding part is positioned on one end of the guiding member far away from the chamber sidewall, and a cross-sectional size of the guiding part gradually decreases along a direction away from the chamber sidewall.

### CROSS-REFERENCE TO RELATED APPLICATIONS

The present application claims priority of Chinese Patent Application No. 202211331499.5, filed on Oct. 28, 2022, titled “cleaning base station, control method thereof and cleaning system”, the contents of which are incorporated herein by reference.

### TECHNICAL FIELD

The present application relates to the field of cleaning robots, and in particular, relates to a cleaning base station, a control method thereof and a cleaning system.

### BACKGROUND

Cleaning robots are automatic devices for cleaning the ground, and they are usually used in cooperation with a cleaning base station, wherein the cleaning base station can maintain the cleaning robots, such as cleaning and charging the cleaning robots.

After the cleaning robot enters the cleaning base station, the cleaning robot is generally aligned by an infrared module of the cleaning base station, and the maintenance for the cleaning robot can only be started when the cleaning robot stops at the accurate position. However, the precise alignment of the cleaning robot is realized only by the infrared module, which makes the control algorithm of the infrared alignment process more demanding.

### SUMMARY

An embodiment of the present application provides a cleaning base station. The cleaning base station includes a base, a first electrode, an infrared module, and a guiding member. The base includes an open chamber capable of accommodating at least a part of a cleaning robot, and the open chamber includes a chamber sidewall extending in an arc shape. The first electrode is arranged on the chamber sidewall, and the first electrode is configured to contact a second electrode of the cleaning robot and charge the cleaning robot. The infrared module is arranged on the chamber sidewall and configured to align the cleaning robot. The guiding member is arranged on the chamber sidewall and protrudes from the chamber sidewall, the guiding member is capable of extending into a guiding groove defined on the cleaning robot, the guiding member includes a guiding part, the guiding part is positioned on one end of the guiding member far away from the chamber sidewall, and a cross-sectional size of the guiding part gradually decreases along a direction away from the chamber sidewall.

Another embodiment of the present application provides a cleaning system. The cleaning system includes a cleaning base station and a cleaning robot. The cleaning base station includes a base, a first electrode, an infrared module, and a guiding member. The base includes an open chamber, and the open chamber includes a chamber sidewall extending in an arc shape. The first electrode is arranged on the chamber sidewall. The infrared module is arranged on the chamber sidewall. The guiding member is arranged on the chamber sidewall and protrudes from the chamber sidewall, the guiding member includes a guiding part, the guiding part is positioned on one end of the guiding member far away from the chamber sidewall, and a cross-sectional size of the guiding part gradually decreases along a direction away from the chamber sidewall. The open chamber is capable of accommodating at least a part of the cleaning robot, the infrared module is configured to align the cleaning robot, the cleaning robot includes a second electrode, the first electrode is configured to contact the second electrode and charge the cleaning robot, the cleaning robot defines a guiding groove capable of accommodating at least a part of the guiding member.

Still another embodiment of the present application provides a method for controlling a cleaning base station. The cleaning base station includes a base, a first electrode, an infrared module, and a guiding member. The base includes an open chamber capable of accommodating at least a part of a cleaning robot, and the open chamber includes a chamber sidewall extending in an arc shape. The first electrode is arranged on the chamber sidewall, and the first electrode is configured to contact a second electrode of the cleaning robot and charge the cleaning robot. The infrared module is arranged on the chamber sidewall and configured to align the cleaning robot. The guiding member is arranged on the chamber sidewall and protrudes from the chamber sidewall, the guiding member is capable of extending into a guiding groove defined on the cleaning robot. The method includes: preliminarily aligning the cleaning robot moving into the open chamber through the infrared module; generating an alignment completion signal after it is detected that a preset condition has been met; and generating a maintenance signal for the cleaning robot according to the alignment completion signal, the maintenance signal including a charging signal, and the charging signal being configured to control the first electrode to charge the cleaning robot, wherein the preset condition includes that: it is detected that the guiding member is embedded in the guiding groove; and the first electrode generates an electrical contact signal that the second electrode is contacted with the first electrode.

### BRIEF DESCRIPTION OF THE DRAWINGS

In order to explain embodiments of the present application or technical solutions in the prior art more clearly, attached drawings required in the description of the embodiments or the prior art will be briefly introduced below; obviously, the attached drawings in the following description are only some embodiments of the present application, and for those of ordinary skill in the art, other drawings can be obtained according to the structures shown in these attached drawings without creative labor.

FIG. 1 is a schematic front view of a cleaning base station according to an embodiment of the present application;

FIG. 2 is a schematic cross-sectional view of a cleaning base station according to an embodiment of the present application;

FIG. 3 is a schematic perspective view of a cleaning robot;

FIG. 4 is a schematic cross-sectional view of the cleaning robot just driving into the cleaning base station during the alignment process;

FIG. 5 is a schematic cross-sectional view of a guiding member just entering a guiding groove during the alignment process;

FIG. 6 is a schematic cross-sectional view of a water injection piece just entering a water injection opening during the alignment process;

FIG. 7 is a schematic cross-sectional view of a second electrode contacting a first electrode and a telescopic member of the first electrode retracting to a second preset position during the alignment process;

FIG. 8 is a schematic front view of a cleaning system according to an embodiment of the present application; and

FIG. 9 is a flowchart diagram of a method for controlling a cleaning base station according to an embodiment of the present application.

### DETAILED DESCRIPTION

Hereinafter, technical solutions in embodiments of the present application will be described clearly and completely with reference to attached drawings in the embodiments of the present application; obviously, the embodiments described are only part but not all of the embodiments of the present application. All other embodiments obtained by those of ordinary skill in the art based on the embodiments of the present application without creative labor belong to the scope claimed in the present application.

It shall be noted that, all directional indicators (such as up, down, left, right, front, back and so on) in the embodiments of the present application are only used to explain relative position relationships and movement situations or the like among components at a specific posture (as shown in the attached drawing); and if the specific posture changes, the directional indicators will change accordingly.

In addition, in the present application, descriptions with terms such as “first”, “second” or the like are only used for descriptive purposes, and should not be understood as indicating or implying the relative importance thereof or implicitly indicating the number of indicated technical features. Therefore, features defined with “first” and “second” may explicitly or implicitly include at least one of the features. In addition, technical solutions among the embodiments can be combined with each other on the basis that they can be realized by those of ordinary skill in the art, and when the combination of the technical solutions is contradictory or impossible to be realized, it should be considered that such combination of the technical solutions does not exist, nor is it within the scope claimed in the present application.

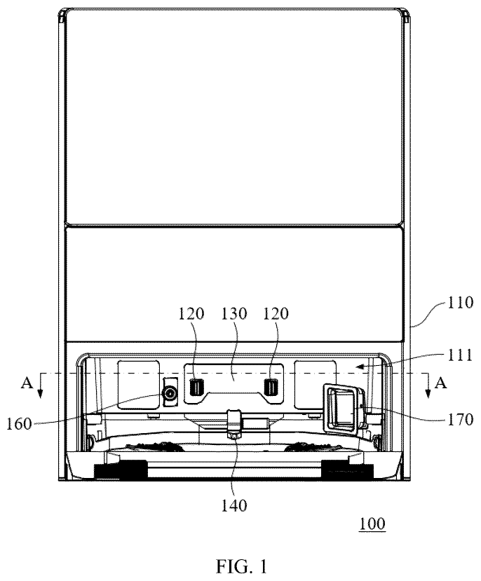

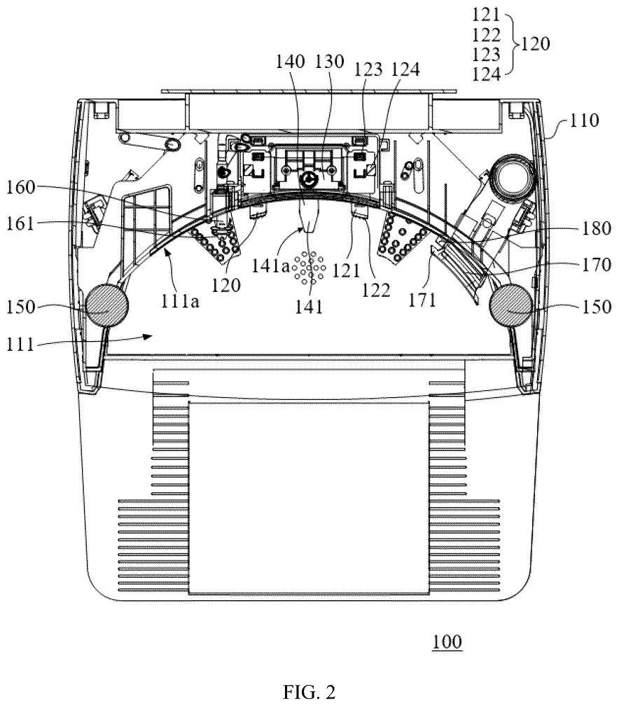

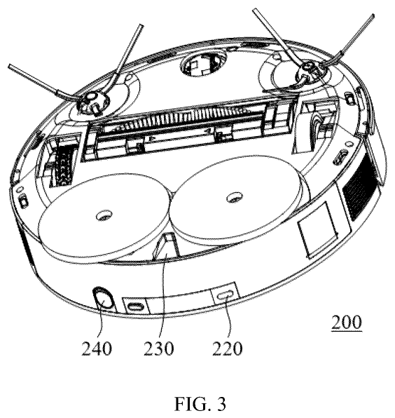

FIG. 1 is a schematic front view of a cleaning base station according to an embodiment of the present application, FIG. 2 is a schematic cross-sectional view of a cleaning base station according to an embodiment of the present application, wherein a line A-A in FIG. 1 shows a position at which the schematic cross-sectional view of FIG. 2 is taken. The cleaning base station 100 is configured to maintain the cleaning robot, FIG. 3 is a schematic perspective view of a cleaning robot, and a cleaning robot 200 involved in FIG. 3 can be used in cooperation with the cleaning base station 100 of the embodiment of the present application; and in order to clearly show the bottom structure of the cleaning robot 200, the cleaning robot 200 will be depicted upside down in FIG. 3.

The cleaning base station 100 includes a base 110, a first electrode 120, an infrared module 130 and a guiding member 140. The base 110 includes an open chamber 111 capable of accommodating at least a part of the cleaning robot 200, and the open chamber 111 includes a chamber sidewall 111a extending in a substantially arc shape. The first electrode 120 is positioned on the chamber sidewall 111a, and is configured to contact a second electrode 220 of the cleaning robot 200 and charge the cleaning robot 200. The infrared module 130 is positioned on the chamber sidewall 111a and configured to align the cleaning robot 200. The guiding member 140 is arranged on the chamber sidewall 111a and protrudes from the chamber sidewall 111a, the guiding member 140 can extend into a guiding groove 230 defined on the cleaning robot 200, one end of the guiding member 140 far away from the chamber sidewall 111a is a guiding part 141, and the cross-sectional size of the guiding part 141 gradually decreases along the direction away from the chamber sidewall 111a.

For the cleaning base station 100 according to the embodiment of the present application, the cleaning base station 100 includes the infrared module 130 and the guiding member 140, wherein the infrared module 130 can preliminarily align the cleaning robot 200, the guiding member 140 protrudes from the chamber sidewall 111a, and the guiding member 140 can extend into the guiding groove 230 of the cleaning robot 200. One end of the guiding member 140 far away from the chamber sidewall 111a is the guiding part 141, and the cross-sectional size of the guiding part 141 gradually decreases along the direction away from the chamber sidewall 111a; in this way, the guiding member 140 can be captured by the guiding groove 230 of the cleaning robot 200 within a preset range, and further accurate alignment of the cleaning robot 200 can be realized through the cooperation of the guiding member 140 and the guiding groove 230, thereby reducing the design difficulty of the control algorithm for the infrared alignment process while realizing accurate alignment of the cleaning robot 200, and thus reducing the design cost of the product.

As shown in FIG. 2, in some embodiments, the guiding part 141 includes two inclined surfaces 141a which are oppositely arranged, and the two inclined surfaces 141a gradually approach each other in the direction away from the chamber sidewall 111a. The guiding groove 230 on the cleaning robot 200 is also provided with an inclined surface matching with the inclined surface 141a of the guiding part 141, and when the cleaning robot 200 moves towards the direction close to the first electrode 120, the inclined surface of the guiding groove 230 contacts the inclined surface 141a of the guiding part 141 such that the guiding part 141 is gradually embedded in the guiding groove 230 centrally, thereby guiding the cleaning robot 200 to move to an accurate alignment position.

In some embodiments, the guiding member 140 is centrally arranged on the arc-shaped extension structure of the chamber sidewall 111a, and the cleaning base station 100 further includes at least two guide components 150. The at least two guide components 150 are arranged on the chamber sidewall 111a, and the at least two guide components 150 are symmetrically distributed on both sides of the guiding member 140; each of the at least two guide components 150 includes at least one roller, and the at least one roller is partially exposed outside the chamber sidewall 111a.

In the above embodiments, the at least two guide components 150 are symmetrically distributed on both sides of the guiding member 140, such that when the cleaning robot 200 deviates to either side of the guiding member 140, the guide component 150 guides the cleaning robot 200 to the central position of the chamber sidewall 111a. Each of the at least two guide components 150 includes at least one roller partially exposed outside the chamber sidewall 111a, and when the sidewall of the cleaning robot 200 contacts the at least one roller, the at least one roller rotates to guide the cleaning robot 200 in the direction closer to the guiding member 140, thereby improving the efficiency of the alignment process of the cleaning robot 200. In addition, since the at least one roller can rotate, the abrasion of the cleaning robot 200 in the process of guiding the cleaning robot 200 can be reduced.

In some embodiments, the cleaning base station 100 further includes a water injection piece 160. The water injection piece 160 is arranged through the chamber sidewall 111a, and the extension axis of the water injection piece 160 is parallel to the extension axis of the guiding member 140, one end of the water injection piece 160 penetrating through the chamber sidewall 111a is a water injection end 161, and the water injection end 161 is in a conical shape which is matched with a trumpet-shaped water injection opening 240 defined on the cleaning robot 200.

In the above embodiments, the extension axis of the water injection piece 160 is parallel to the extension axis of the guiding member 140, and the water injection end 161 of the water injection piece 160 is in a conical shape which is matched with the trumpet-shaped water injection opening 240 defined on the cleaning robot 200; when the water injection piece 160 just contacts the water injection opening 240, the cleaning robot 200 is allowed to adjust its position within a certain error range, and when the cleaning robot 200 continues to move forward, the fitting accuracy of the water injection end 161 of the water injection piece 160 with the water injection opening 240 is gradually improved. When the cleaning robot 200 reaches the preset position, the water injection end 161 of the water injection piece 160 is embedded into the water injection opening 240, such that the second electrode 220 of the cleaning robot 200 contacts the first electrode 120 of the cleaning base station 100 accurately and stably. By the cooperation between the water injection piece 160 and the water injection opening 240, in combination with the cooperation between the guiding member 140 and the guiding groove 230 as well as the preliminary alignment of the infrared module 130, the precise alignment position of the cleaning robot 200 can be confirmed from multiple perspectives, thereby improving the alignment accuracy of the cleaning robot 200.

In some embodiments, the first electrode 120 includes a telescopic member 121, a first electrical connector 122, and an elastic member 123. The telescopic member 121 is telescopically arranged on the chamber sidewall 111a. The first electrical connector 122 is arranged on an end face of one side of the telescopic member 121 penetrating through the chamber sidewall 111a. The elastic member 123 elastically connects the telescopic member 121 with the base 110, and the elastic member 123 can reset the telescopic member 121 to the first preset position extending outward relative to the chamber sidewall 111a. In the above embodiments, the first electrode 120 includes the telescopic member 121, the first electrical connector 122 and the elastic member 123, and when the first electrode 120 contacts the second electrode 220 of the cleaning robot 200, the telescopic arrangement of the telescopic member 121 enables the first electrode 120 to adaptively adjust the position thereof with respect to the position of second electrode 220 to a certain extent, and thus the elastic member 123 ensures that the electrical contact between the first electrode 120 and the second electrode 220 is more stable.

In some embodiments, the extension axis of the telescopic member 121 is parallel to the extension axis of the guiding member 140. The first electrode 120 further includes a retraction completion detection module 124 located in the base 110. The retraction completion detection module 124 is configured to generate a retraction completion signal when the telescopic member 121 retracts to a second preset position. The retraction completion detection module 124 is, for example, a switching element, and when the telescopic member 121 retracts to the second preset position, the switching element is triggered as a retraction completion signal. The retraction completion detection module 124 can also be configured to confirm whether the cleaning robot 200 reaches the precise alignment position, and when the telescopic member 121 retracts to the second preset position, the retraction completion detection module 124 generates a retraction completion signal; by means of the retraction completion signal, in combination with the cooperation between the guiding member 140 and the guiding groove 230 as well as the preliminary alignment of the infrared module 130, the precise alignment position of the cleaning robot 200 can be confirmed from more perspectives, thereby further improving the alignment accuracy of the cleaning robot 200.

The cleaning base station 100 may further include a dust collection opening 170, and the dust collection opening 170 is arranged to extend out of the chamber sidewall 111a. In some embodiments, one end of the dust collection opening 170 extending out of the chamber sidewall 111a has an outward expanding part 171, and the dust collection opening 170 is a flexible structure, such as a silica gel structure. In some embodiments, the cleaning base station 100 may further include a travel switch 180, which is positioned on the chamber sidewall 111a and located at the dust collection opening 170. The travel switch 180 will be triggered when the dust collection opening 170 is squeezed and deformed until the outward expanding part 171 squeezes the travel switch 180. Whether the travel switch 180 is triggered can also be used to confirm whether the cleaning robot 200 reaches the precise alignment position. When the cleaning robot 200 travels to the precise alignment position, the cleaning robot 200 squeezes the dust collection opening 170, such that the dust collection opening 170 is deformed, and the deformation of the dust collection opening 107 makes the outward expanding part 171 squeeze the travel switch 180, and at this time, the travel switch 180 is triggered to generate an electrical signal, which can be used as a basis for determining whether the cleaning robot 200 reaches the precise alignment position; by means of the electrical signal, in combination with the cooperation between the guiding member 140 and the guiding groove 230 as well as the preliminary alignment of the infrared module 130, the precise alignment position of the cleaning robot 200 can be confirmed from more perspectives, thereby further improving the alignment accuracy of the cleaning robot 200.

In one example, the cleaning base station 100 includes a base 110, a first electrode 120, an infrared module 130, a guiding member 140, at least two guide components 150, a water injection piece 160, and a dust collection opening 170. One end of the guiding member 140 away from the chamber sidewall 111a is a guiding part 141, and the cross-sectional size of the guiding part 141 gradually decreases along the direction away from the chamber sidewall 111a. The extension axis of the water injection piece 160 is parallel to the extension axis of the guiding member 140, one end of the water injection piece 160 penetrating through the chamber sidewall 111a is a water injection end 161, and the water injection end 161 is in a conical shape which is matched with the trumpet-shaped water injection opening 240 defined on the cleaning robot 200. The first electrode 120 includes a telescopic member 121, a first electrical connector 122, an elastic member 123, and a retraction completion detection module 124. The extension axis of the telescopic member 121 is parallel to the extension axis of the guiding member 140. The retraction completion detection module 124 is configured to generate a retraction completion signal when the telescopic member 121 retracts to the second preset position.

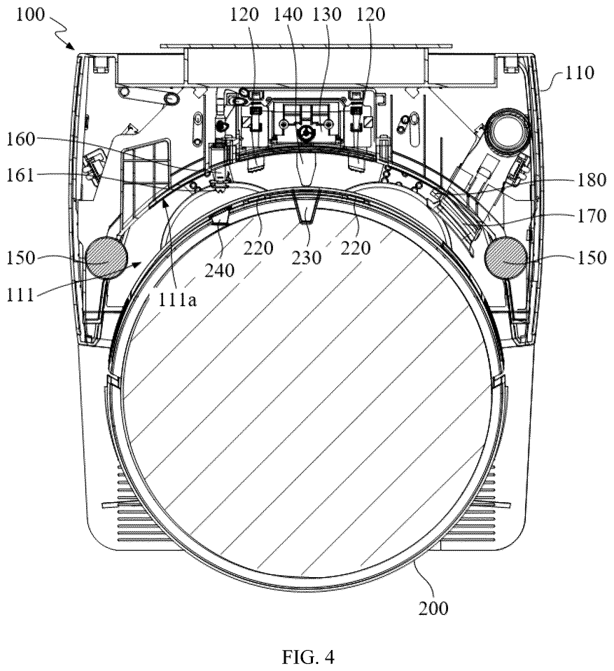

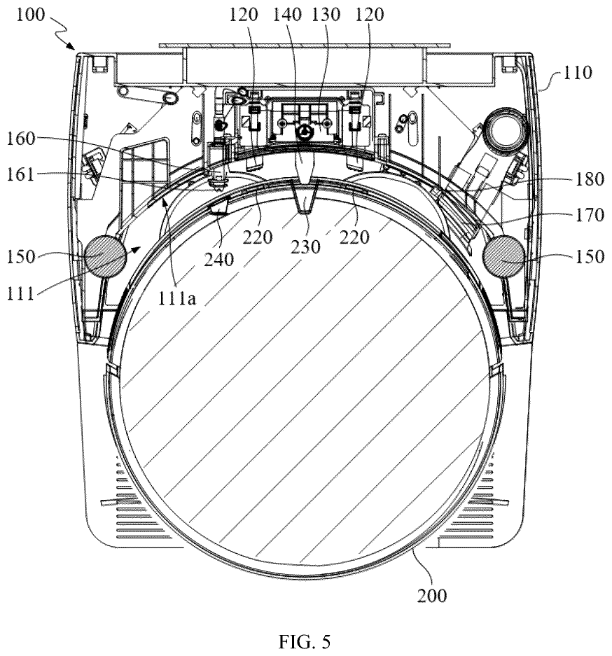

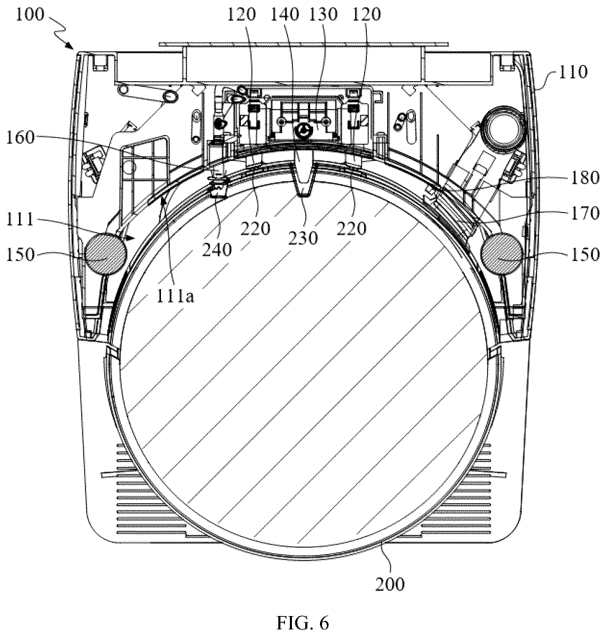

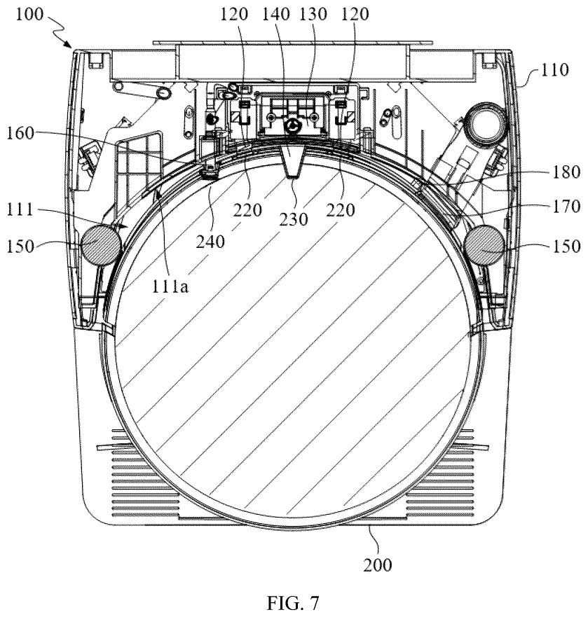

Hereinafter, the specific process when the cleaning base station 100 of the above example is used to maintain the cleaning robot 200 will be described with reference to FIG. 4 to FIG. 7. FIG. 4 is a schematic cross-sectional view of the cleaning robot 200 just driving into the cleaning base station 100 during the alignment process, and when the cleaning robot 200 drives to the open chamber 111 of the cleaning base station 100, the cleaning base station 100 preliminarily aligns the cleaning robot 200 through the infrared module 130, and guides the cleaning robot 200 to advance along a guide plate provided for the cleaning base station 100, and the walking wheels of the cleaning robot 200 will enter the open chamber 111 of the cleaning base station 100 along the guide path on the guide plate. After the cleaning robot 200 enters the open chamber 111, firstly, the cleaning robot 200 will contact the guide component 150, and under the guidance for preliminary alignment of the infrared module 130, the cleaning robot 200 will continuously adjust the posture thereof while moving forward, such that the cleaning robot 200 is adjusted to a suitable position to identify the preliminary position of the guiding member 140, as shown in FIG. 5 which is a schematic cross-sectional view of the guiding member 140 just entering the guiding groove 230 during the alignment process; then, when the cleaning robot 200 advances, the guiding groove 230 cooperates with the guiding member 140, and the guide component 150 guides and limits the position of the cleaning robot 200, so as to guide the cleaning robot 200 to be positioned at a preset position and realize the alignment between the water injection opening 240 of the cleaning robot 200 and the extension axis of the water injection piece 160, as shown in FIG. 6 which is a schematic cross-sectional view of the water injection piece 160 just entering the water injection opening 240 during the alignment process, and the cleaning robot 200 can further enter the station only after the guiding groove 230 of the cleaning robot 200 successfully cooperates with the guiding member 140, otherwise the cleaning robot 200 cannot carry out the next operation; then, the water injection piece 160 cooperates with the water injection opening 240, and when the water injection piece 160 reaches the preset position in the water injection opening 240, the first electrical connector 122 of the first electrode 120 can contact the second electrode 220 of the cleaning robot 200; when the cleaning base station 100 can receive the electrical signal sent by the cleaning robot 200 through the first electrode 120, it indicates that all functional component interfaces are aligned, i.e., the cleaning robot 200 has successfully entered the station, and at this point, the cleaning base station 100 can send an instruction of stopping the rotation of the walking wheels to the cleaning robot 200 to stop the movement of the cleaning robot 200, and send a working instruction to the functional components; when the cleaning base station 100 fails to receive the electrical signal of the cleaning robot 200 via the first electrode 120, the cleaning robot 200 is controlled to retreat for a certain distance, such that the posture thereof is readjusted to repeat the above steps; furthermore, in this example, it may be set that the electrical signal sent by the cleaning robot 200 can be received only after the first electrical connector 122 of the first electrode 120 fully contacts the charging contact of the second electrode 220 of the cleaning robot 200; further, in this example, the first electrode 120 is an elastic and retractable structure, and the electrical signal sent by the cleaning robot 200 can be received to trigger an instruction for the cleaning base station 100 to perform work on the cleaning robot 200 only after the second electrode 220 of the cleaning robot 200 contacts the first electrode 120 and the telescopic member 121 of the first electrode 120 retracts to the second preset position, as shown in FIG. 7 which is a schematic cross-sectional view of the second electrode 220 contacting the first electrode 120 and the telescopic member 121 of the first electrode 120 retracting to the second preset position during the alignment process. This trigger mechanism adopts mechanical alignment to realize the rapid and accurate parking of the cleaning robot 200, which reduces the accuracy required by the infrared alignment mode, reduces the manufacturing cost, and also improves the use safety of triggering the cleaning base station 100 to work.

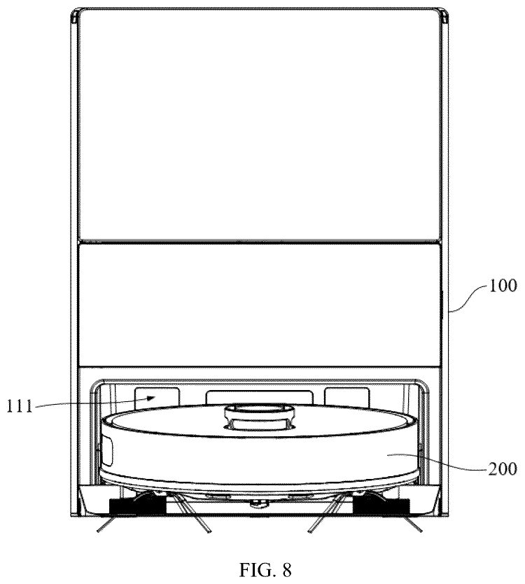

An embodiment of the present application provides a cleaning system, and FIG. 8 is a schematic front view of a cleaning system according to an embodiment the present application. The cleaning system includes the cleaning base station 100 and the cleaning robot 200 in any of the aforementioned embodiments.

The cleaning base station 100 includes a base 110, a first electrode 120, an infrared module 130 and a guiding member 140. The base 110 includes an open chamber 111 capable of accommodating at least a part of the cleaning robot 200, and the open chamber 111 includes a chamber sidewall 111a extending in a substantially arc shape. The first electrode 120 is positioned on the chamber sidewall 111a, and is configured to contact a second electrode 220 of the cleaning robot 200 and charge the cleaning robot 200. The infrared module 130 is positioned on the chamber sidewall 111a for aligning the cleaning robot 200. The guiding member 140 is arranged on the chamber sidewall 111a and protrudes from the chamber sidewall 111a, the guiding member 140 can extend into a guiding groove 230 defined on the cleaning robot 200, one end of the guiding member 140 far away from the chamber sidewall 111a is a guiding part 141, and the cross-sectional size of the guiding part 141 gradually decreases along the direction away from the chamber sidewall 111a.

The cleaning robot 200 can move into the open chamber 111 of the cleaning base station 100, the cleaning robot 200 defines the guiding groove 230, which can accommodate at least a part of the guiding member 140 of the cleaning base station 100.

For the cleaning system according to the embodiment of the present application, the cleaning base station 100 includes the infrared module 130 and the guiding member 140, wherein the infrared module 130 can preliminarily align the cleaning robot 200, the guiding member 140 protrudes from the chamber sidewall 111a, and the guiding member 140 can extend into the guiding groove 230 of the cleaning robot 200. One end of the guiding member 140 far away from the chamber sidewall 111a is the guiding part 141, and the cross-sectional size of the guiding part 141 gradually decreases along the direction away from the chamber sidewall 111a; in this way, the guiding member 140 can be captured by the guiding groove 230 of the cleaning robot 200 within a preset range, and further accurate alignment of the cleaning robot 200 can be realized through the cooperation of the guiding member 140 and the guiding groove 230, thereby reducing the design difficulty of the control algorithm for the infrared alignment process while realizing accurate alignment of the cleaning robot 200, and thus reducing the design cost of the product.

An embodiment of the present application further provides a method for controlling a cleaning base station, and the method for controlling a cleaning base station can be applied to the cleaning base station 100 in any of the aforementioned embodiments. The cleaning base station 100 includes a base 110, a first electrode 120, an infrared module 130 and a guiding member 140. The base 110 includes an open chamber 111 capable of accommodating at least a part of the cleaning robot 200, and the open chamber 111 includes a chamber sidewall 111a extending in a substantially arc shape. The first electrode 120 is positioned on the chamber sidewall 111a, and is configured to contact a second electrode 220 of the cleaning robot 200 and charge the cleaning robot 200. The infrared module 130 is positioned on the chamber sidewall 111a for aligning the cleaning robot 200. The guiding member 140 is arranged on the chamber sidewall 111a and protrudes from the chamber sidewall 111a, the guiding member 140 can extend into a guiding groove 230 defined on the cleaning robot 200, one end of the guiding member 140 far away from the chamber sidewall 111a is a guiding part 141, and the cross-sectional size of the guiding part 141 gradually decreases along the direction away from the chamber sidewall 111a.

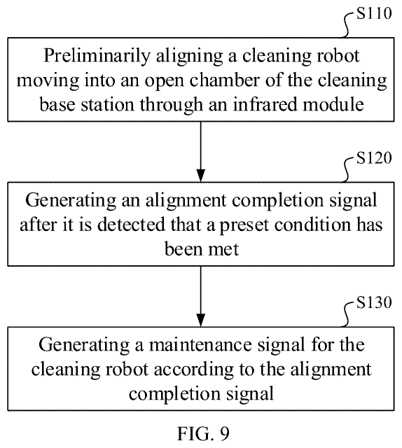

FIG. 9 is a flowchart diagram of the method for controlling a cleaning base station according to an embodiment of the present application, and in this embodiment, the method for controlling the cleaning base station includes steps S110 to S130.

In step S110, a cleaning robot 200 moving into an open chamber 111 of the cleaning base station 100 is preliminarily aligned through an infrared module 130.

In step S120, an alignment completion signal is generated after it is detected that a preset condition has been met. In this embodiment, the preset condition includes that: it is detected that a guiding member 140 of the cleaning base station 100 is embedded in a guiding groove 230 of the cleaning robot 200; and the first electrode 120 of the cleaning base station 100 generates an electrical contact signal that a second electrode 220 of the cleaning robot 200 is contacted.

In step S130, a maintenance signal for the cleaning robot 200 is generated according to the alignment completion signal, wherein the maintenance signal includes a charging signal, and the charging signal is configured to control the first electrode 120 of the cleaning base station 100 to charge the cleaning robot 200.

For the method for controlling the cleaning base station according to the embodiment of the present application, the cleaning robot 200 moving into the open chamber 111 of the cleaning base station 100 is preliminarily aligned through the infrared module 130, in this step, the design difficulty of the control algorithm applied to the infrared module 130 is relatively low, and it is unnecessary to use the infrared module 130 to realize accurate positioning for the cleaning robot 200, and the infrared module 130 only needs to be capable of guiding the guiding groove 230 of the cleaning robot 200 to cooperate with the guiding member 140 of the cleaning base station 100. The method for controlling the cleaning base station includes generating an alignment completion signal after it is detected that a preset condition has been met, wherein the preset condition includes that: it is detected that the guiding member 140 of the cleaning base station 100 is embedded in the guiding groove 230 of the cleaning robot 200; and the first electrode 120 of the cleaning base station 100 generates an electrical contact signal that the second electrode 220 of the cleaning robot 200 is contacted. In the embodiment of the present application, the condition for generating the alignment completion signal, in combination with the preliminary alignment of the infrared module 130, the cooperation between the guiding member 140 and the guiding groove 230 as well as the electrical contact and cooperation between the first electrode 120 and the second electrode 220, confirms the precise alignment position of the cleaning robot 200 from multiple perspectives, improves the alignment accuracy of the cleaning robot 200, and reduces the design difficulty of the control algorithm in the infrared alignment process, thereby reducing the design cost of the product. In the method of the embodiment of the present application, the maintenance signal for the cleaning robot 200 is generated according to the alignment completion signal; that is, the maintenance for the cleaning robot 200 is started only after the accurate alignment of the cleaning robot 200 is completed, thereby avoiding some maintenance abnormalities caused by triggering the maintenance work before the cleaning robot 200 is parked at a proper position.

In some embodiments, the guiding member 140 of the cleaning base station 100 is centrally positioned on the arc-shaped extension structure of the chamber sidewall 111a. The cleaning base station 100 further includes at least two guide components 150 which are arranged on the chamber sidewall 111a, the at least two guide components 150 are symmetrically distributed on both sides of the guiding member 140, each of the at least two guide components 150 includes at least one roller, and the at least one roller is partially exposed outside the chamber sidewall 111a. Therefore, in the above embodiment, in step S120, the preset condition may further include that: it is detected that a water injection end 161 of a water injection piece 160 of the cleaning base station 100 is embedded into a trumpet-shaped water injection opening 240 of the cleaning robot 200. At this time, by detecting the cooperation between the water injection piece 160 and the water injection opening 240, in combination with the detection of the cooperation between the guiding member 140 and the guiding groove 230, the electrical contact and cooperation between the first electrode 120 and the second electrode 220 as well as the preliminary alignment of the infrared module 130, the precise alignment position of the cleaning robot 200 can be confirmed from multiple perspectives, thereby improving the alignment accuracy of the cleaning robot 200.

In some embodiments, the first electrode 120 of the cleaning base station 100 includes a telescopic member 121, a first electrical connector 122, and an elastic member 123. The telescopic member 121 is telescopically arranged on the chamber sidewall 111a. The first electrical connector 122 is arranged on an end face of one side of the telescopic member 121 penetrating through the chamber sidewall 111a. The elastic member 123 elastically connects the telescopic member 121 with the base 110, and the elastic member 123 can reset the telescopic member 121 to the first preset position extending outward relative to the chamber sidewall 111a. In the above embodiment, in step S120, the preset condition may further include that the telescopic member 121 of the cleaning base station 100 retracts to a second preset position. Further, the extension axis of the telescopic member 121 is parallel to the extension axis of the guiding member 140. The first electrode 120 may further include a retraction completion detection module 124 located in the base 110, and the retraction completion detection module 124 is configured to generate a retraction completion signal when the telescopic member 121 retracts to a second preset position. Therefore, in the above embodiment, it may be determined whether the telescopic member 121 of the cleaning base station 100 is retracted to the second preset position by the retraction completion detection module 124; that is, in step S120, the preset condition may include that the retraction completion detection module 124 of the cleaning base station 100 generates a retraction completion signal. At this time, by detecting whether the telescopic member 121 retracts to the second preset position, in combination with the detection of the cooperation between the guiding member 140 and the guiding groove 230, the electrical contact and cooperation between the first electrode 120 and the second electrode 220 as well as the preliminary alignment of the infrared module 130, the precise alignment position of the cleaning robot 200 can be confirmed from multiple perspectives, thereby improving the alignment accuracy of the cleaning robot 200.

In some embodiments, the cleaning base station 100 further includes a dust collection opening 170 and a travel switch 180. The dust collection opening 170 extends out of the chamber sidewall 111a, and one end of the dust collection opening 170 extending out of the chamber sidewall 111a has an outward expanding part 171, and the dust collection opening 170 is a flexible structure. The travel switch 180 is positioned on the chamber sidewall 111a and located at the dust collection opening 170, and the travel switch 180 will be triggered when the dust collection opening 170 is squeezed and deformed until the outward expanding part 171 squeezes the travel switch 180. Therefore, in the above embodiment, in step S120, the preset condition may further include that the travel switch 180 of the cleaning base station 100 has been triggered. At this time, by detecting whether the travel switch 180 at the dust collection opening 170 is triggered, in combination with the detection of the cooperation between the guiding member 140 and the guiding groove 230, the electrical contact and cooperation between the first electrode 120 and the second electrode 220 as well as the preliminary alignment of the infrared module 130, the precise alignment position of the cleaning robot 200 can be confirmed from multiple perspectives, thereby improving the alignment accuracy of the cleaning robot 200.

In some embodiments, in step S130, the maintenance signal further includes a dust collection signal, a cleaning signal, a water injection signal, and a drying signal. The dust collection signal is used to control a dust collection mechanism of the cleaning base station 100 to suck a dust box of the cleaning robot 200 through the dust collection opening 170. The cleaning signal is configured to control a cleaning mechanism of the cleaning base station 100 to clean a cleaning member of the cleaning robot 200. The water injection signal is configured to control a water injection mechanism of the cleaning base station 100 to inject water into a water storage container of the cleaning robot 200 through the water injection piece 160. The drying signal is configured to control a drying mechanism of the cleaning base station 100 to dry the cleaning member of the cleaning robot 200.

In this embodiment, the dust collection signal, the cleaning signal, the water injection signal, the drying signal and the charging signal are generated in sequence. Specifically, the controller of the cleaning base station 100 sends the dust collection signal to the dust collection mechanism, and the dust collection mechanism performs a suction operation on the dust box of the cleaning robot 200, and pumps the garbage in the dust box into the dust collection mechanism. After the dust collection operation is finished, the controller stops the work of the dust collection mechanism, sends a cleaning signal to a self-cleaning mechanism to clean the cleaning member of the cleaning robot 200 (the cleaning member of the cleaning robot 200 is, for example, a mop) and recycle the treated sewage. After the cleaning process is finished, the controller stops the work of the cleaning mechanism, sends a water injection signal to the water injection mechanism to inject water into the water storage container of the cleaning robot 200 through the water injection piece 160. Thereafter, the controller sends a drying signal to the drying mechanism to control the drying mechanism to dry the cleaning member of the cleaning robot 200. After the drying operation is finished, a charging signal is sent to the charging mechanism to control the charging mechanism to charge the cleaning robot 200 through the first electrode 120. Because the dust collection signal, the cleaning signal, the water injection signal, the drying signal and the charging signal are generated in sequence, the maintenance process of the cleaning robot 200 is basically carried out according to the steps of first processing dry garbage, then cleaning the cleaning robot 200, then drying the cleaning robot 200, and finally charging the cleaning robot 200; in this way, on the one hand, the phenomenon of secondary pollution can be reduced, and on the other hand, the failure of electrical leakage can be prevented.

What described above are only the exemplary embodiments of the present application, but are not intended to limit the protective scope of the present application; any equivalent structures or equivalent process modifications that are made according to the specification and the attached drawings of the present application, or any direct or indirect applications of the present application in other related technical fields shall all be covered within the protective scope of the present application.

What is claimed is:

1. A cleaning base station, comprising:
a base, comprising an open chamber capable of accommodating at least a part of a cleaning robot, and the open chamber comprising a chamber sidewall extending in an arc shape;
a first electrode, arranged on the chamber sidewall, and the first electrode configured to contact a second electrode of the cleaning robot and charge the cleaning robot;
an infrared module, arranged on the chamber sidewall and configured to align the cleaning robot; and
a guiding member, arranged on the chamber sidewall and protruding from the chamber sidewall, the guiding member capable of extending into a guiding groove defined on the cleaning robot, wherein the guiding member comprises a guiding part, the guiding part is positioned on one end of the guiding member far away from the chamber sidewall, and a cross-sectional size of the guiding part gradually decreases along a direction away from the chamber sidewall.

2. The cleaning base station of claim 1, wherein the guiding part comprises two inclined surfaces which are oppositely arranged, and the two inclined surfaces gradually approach each other along the direction away from the chamber sidewall.

3. The cleaning base station of claim 1, wherein the guiding member is centrally arranged on an arc-shaped extension structure of the chamber sidewall, and the cleaning base station further comprises:
at least two guide components, arranged on the chamber sidewall, the at least two guide components are symmetrically distributed on both sides of the guiding member, and each of the at least two guide components comprises at least one roller, and the at least one roller is partially exposed outside the chamber sidewall.

4. The cleaning base station of claim 1, further comprising:
a water injection piece, arranged through the chamber sidewall, wherein an extension axis of the water injection piece is parallel to an extension axis of the guiding member, one end of the water injection piece penetrating through the chamber sidewall is a water injection end, the water injection end is in a conical shape, and the conical shaped water injection end is matched with a trumpet-shaped water injection opening defined on the cleaning robot.

5. The cleaning base station of claim 1, wherein the first electrode comprises:
a telescopic member, telescopically arranged on the chamber sidewall;
a first electrical connector, arranged on an end face of one side of the telescopic member penetrating through the chamber sidewall; and
an elastic member, elastically connecting the telescopic member with the base, wherein the elastic member is capable of resetting the telescopic member to a first preset position extending outwards relative to the chamber sidewall.

6. The cleaning base station of claim 5, wherein the first electrode further comprises a retraction completion detection module located in the base, the retraction completion detection module is configured to generate a retraction completion signal when the telescopic member retracts to a second preset position.

7. The cleaning base station of claim 5, wherein an extension axis of the telescopic member is parallel to the extension axis of the guiding member.

8. The cleaning base station of claim 1, wherein the cleaning base station further comprises a dust collection opening and a travel switch, the dust collection opening extends out of the chamber sidewall, the dust collection opening comprises an outward expanding part positioned on one end of the dust collection opening extending out of the chamber sidewall, the travel switch is positioned on the chamber sidewall and located at the dust collection opening, and when the dust collection opening is squeezed and deformed until the outward expanding part squeezes the travel switch, the travel switch is triggered.

9. A cleaning system, comprising:
a cleaning base station comprising:
a base, comprising an open chamber, and the open chamber comprising a chamber sidewall extending in an arc shape;
a first electrode, arranged on the chamber sidewall;
an infrared module, arranged on the chamber sidewall; and
a guiding member, arranged on the chamber sidewall and protruding from the chamber sidewall, the guiding member comprising a guiding part, the guiding part positioned on one end of the guiding member far away from the chamber sidewall, and a cross-sectional size of the guiding part gradually decreasing along a direction away from the chamber sidewall; and
a cleaning robot, the open chamber capable of accommodating at least a part of the cleaning robot, the infrared module configured to align the cleaning robot, the cleaning robot comprising a second electrode, the first electrode configured to contact the second electrode and charge the cleaning robot, the cleaning robot defining a guiding groove capable of accommodating at least a part of the guiding member.

10. The cleaning system of claim 9, wherein the guiding part comprises two inclined surfaces which are oppositely arranged, and the two inclined surfaces gradually approach each other along the direction away from the chamber sidewall.

11. The cleaning system of claim 9, wherein the guiding member is centrally arranged on an arc-shaped extension structure of the chamber sidewall, and the cleaning base station further comprises:
at least two guide components, arranged on the chamber sidewall, the at least two guide components are symmetrically distributed on both sides of the guiding member, and each of the at least two guide components comprises at least one roller, and the at least one roller is partially exposed outside the chamber sidewall.

12. The cleaning system of claim 9, wherein the cleaning base station further comprises:
a water injection piece, arranged through the chamber sidewall, wherein an extension axis of the water injection piece is parallel to an extension axis of the guiding member, one end of the water injection piece penetrating through the chamber sidewall is a water injection end, the water injection end is in a conical shape, and the conical shaped water injection end is matched with a trumpet-shaped water injection opening defined on the cleaning robot.

13. The cleaning system of claim 9, wherein the first electrode comprises:
a telescopic member, telescopically arranged on the chamber sidewall;
a first electrical connector, arranged on an end face of one side of the telescopic member penetrating through the chamber sidewall;
an elastic member, elastically connecting the telescopic member with the base, wherein the elastic member is capable of resetting the telescopic member to a first preset position extending outwards relative to the chamber sidewall.

14. The cleaning system of claim 9, wherein the cleaning base station further comprises a dust collection opening and a travel switch, the dust collection opening extends out of the chamber sidewall, the dust collection opening comprises an outward expanding part positioned on one end of the dust collection opening extending out of the chamber sidewall, the travel switch is positioned on the chamber sidewall and located at the dust collection opening, and when the dust collection opening is squeezed and deformed until the outward expanding part squeezes the travel switch, the travel switch is triggered.

15. A method for controlling a cleaning base station, the cleaning base station comprising:
a base, comprising an open chamber capable of accommodating at least a part of a cleaning robot, and the open chamber comprising a chamber sidewall extending in an arc shape;
a first electrode, arranged on the chamber sidewall, and the first electrode configured to contact a second electrode of the cleaning robot and charge the cleaning robot;
an infrared module, arranged on the chamber sidewall and configured to align the cleaning robot; and
a guiding member, arranged on the chamber sidewall and protruding from the chamber sidewall, the guiding member capable of extending into a guiding groove defined on the cleaning robot;
the method comprising:
preliminarily aligning the cleaning robot moving into the open chamber through the infrared module;
generating an alignment completion signal after it is detected that a preset condition has been met; and
generating a maintenance signal for the cleaning robot according to the alignment completion signal, the maintenance signal comprising a charging signal, and the charging signal being configured to control the first electrode to charge the cleaning robot;
wherein the preset condition comprises that:
it is detected that the guiding member is embedded in the guiding groove; and
the first electrode generates an electrical contact signal that the second electrode is contacted with the first electrode.

16. The method of claim 15, wherein the cleaning base station comprises:
a water injection piece, arranged through the chamber sidewall, wherein an extension axis of the water injection piece is parallel to an extension axis of the guiding member, one end of the water injection piece penetrating through the chamber sidewall is a water injection end, the water injection end is in a conical shape, and the conical shaped water injection end is matched with a trumpet-shaped water injection opening defined on the cleaning robot;
the preset condition further comprises that:
it is detected that the water injection end is embedded into the trumpet-shaped water injection opening.

17. The method of claim 15, wherein the first electrode comprises:
a telescopic member, telescopically arranged on the chamber sidewall;
a first electrical connector, arranged on an end face of one side of the telescopic member penetrating through the chamber sidewall; and
an elastic member, elastically connecting the telescopic member with the base, wherein the elastic member is capable of resetting the telescopic member to a first preset position extending outwards relative to the chamber sidewall;
the preset condition further comprises that:
the telescopic member retracts to a second preset position.

18. The method of claim 17, wherein the first electrode further comprises a retraction completion detection module located in the base, the retraction completion detection module generates a retraction completion signal when the telescopic member retracts to the second preset position.

19. The method of claim 15, wherein the cleaning base station further comprises a dust collection opening and a travel switch, the dust collection opening extends out of the chamber sidewall, the dust collection opening comprises an outward expanding part positioned on one end of the dust collection opening extending out of the chamber sidewall, the travel switch is positioned on the chamber sidewall and located at the dust collection opening;
the preset condition further comprises that:
the outward expanding part squeezes the travel switch, such that the travel switch is triggered.

20. The method of claim 15, wherein the maintenance signal further comprises:
a dust collection signal, configured to control a dust collection mechanism of the cleaning base station to suck a dust box of the cleaning robot through a dust collection opening of the cleaning base station;
a cleaning signal, configured to control a cleaning mechanism of the cleaning base station to clean a cleaning member of the cleaning robot;
a water injection signal, configured to control a water injection mechanism of the cleaning base station to inject water into a water storage container of the cleaning robot through a water injection piece of the cleaning base station; and
a drying signal, configured to control a drying mechanism of the cleaning base station to dry the cleaning member of the cleaning robot;
wherein the dust collection signal, the cleaning signal, the water injection signal, the drying signal and the charging signal are generated in sequence.
